(19) United States
(12) Patent Application Publication
(10) Pub. No.: US 2025/0328950 A1
(43) Pub. Date: Oct. 23, 2025

(54) LOCATION-BASED PUSH NOTIFICATIONS FOR CONSUMABLES

(71) Applicant: Midea Group Co., Ltd., Foshan (CN)

(72) Inventor: Michael Grant, Taylorsville, KY (US)

(73) Assignee: Midea Group Co., Ltd., Foshan (CN)

(21) Appl. No.: 18/642,611

(22) Filed: Apr. 22, 2024

(51) Int. Cl. G06Q 30/0601; G06Q 10/0875; G06Q 10/20

(52) U.S. Cl. CPC G06Q 30/0639; G06Q 10/0875; G06Q 10/20

(57) ABSTRACT

A logistics system uses an application to push notifications as a function of proximity for an appliance that needs a part for replacement. The logistics system consists of a sensor, a parts algorithm, an inventory database, a trilateration sensor, a routing algorithm, and an alerting module. The sensor at a first location detects usage of the appliance. The parts algorithm determines the part which is needed for the appliance. The inventory database at a second location stores inventory information for multiple parts of the appliance. The communication interface transmits data between two locations and the trilateration sensor tracks a location of the user device. The routing algorithm determines distance between the location of the user device and different locations having the part. Finally, the alerting module of the user device triggers when location of the user device is within a determined distance from different locations having the part in stock.

### BACKGROUND

This disclosure relates, in general, to mobile applications for consumables and, not by way of limitation, to tracking nearby locations for replacing consumables, among other things.

Consumables are an integral part of various industries, encompassing everything from office supplies to manufacturing materials. However, one of the significant challenges associated with consumables is, the uncertainty surrounding the ideal time for replacing their components. This issue is particularly prevalent in contexts where consumables are used in equipment or machinery, as the failure to replace components promptly can lead to operational inefficiencies, increased maintenance costs, and even safety hazards.

In many cases, the lack of clear indicators or guidelines, for when to replace consumable components can result in a reactive rather than proactive approach to maintenance. A lack of proactive monitoring and replacement schedules, businesses may experience unexpected downtimes, due to equipment failures or suboptimal performance. Moreover, the uncertainty regarding component lifespans can lead to unnecessary stockpiling of consumables, tying up valuable resources and storage space.

In conclusion, the issue of not knowing when to replace consumable components poses significant challenges, for businesses across various industries. However, with new technological organizations one can overcome these challenges, and optimize their consumable management processes for improved efficiency and reliability.

### SUMMARY

In one embodiment, the present disclosure provides a logistics system that uses an application to push a notification as a function of proximity for an appliance that needs a part for replacement. The logistics system consists of a sensor, a parts algorithm, an inventory database, a trilateration sensor, a routing algorithm, and an alerting module. The sensor at a first location detects usage of the appliance. The parts algorithm determines the part needed for the appliance. The inventory database at a second location stores inventory information for multiple parts of the appliance. The communication interface transmits data between two locations and the trilateration sensor tracks a location of the user device. The routing algorithm determines distance between the location of the user device and different locations having the part. Finally, the alerting module of the user device triggers when location of the user device is within a determined distance from different locations having the part in stock.

In an embodiment, a logistics system that uses an application to push a notification as a function of proximity for an appliance that needs a part for replacement. The logistics system consists of a sensor, a parts algorithm, an inventory database, a trilateration sensor, a routing algorithm, and an alerting module. The sensor at a first location detects usage of the appliance and the sensor for detecting usage of the appliance is a usage timer. The parts algorithm uses data from the sensor to determine the part needed for the appliance. The inventory database at a second location stores inventory information at different locations for multiple parts for the appliance. The communication interface for the appliance transmits data between the first location and the second location. The sensor contacts the inventory database when the appliance is getting faulty and/or the appliance needs the part for replacement. The trilateration sensor tracks a location of the user device. The routing algorithm determines distance between the location of the user device and different locations having the part. Based on information from the trilateration sensor and routing algorithm, the alerting module of the user device triggers when the location of the user device is within a determined distance from different locations having the part in stock. The logistics system further provides recommendations to the user towards purchasing the part for the appliance from an original equipment manufacturer instead of getting a replica.

In another embodiment, a logistics method that uses an application to push a notification as a function of proximity for an appliance that needs a part for replacement. The logistics method consists of detecting usage of the appliance via a sensor at a first location and the sensor for detecting usage of the appliance is a usage timer. The logistics method further includes using data from the sensor to determine the part needed for the appliance and storing inventory information at different locations for multiple parts for the appliance through an inventory database at a second location. The logistics method further includes transmitting data for the appliance between the first location and the second location. The sensor contacts the inventory database when the appliance is getting faulty and/or the appliance needs the part for replacement. The logistics method further includes tracking a location of the user device using a trilateration sensor and determining distance between the location of the user device and different locations having the part by a routing algorithm. Based on information from the trilateration sensor and routing algorithm, triggering the alerting module of the user device when the location of the user device is within a determined distance from different locations having the part in stock. The logistics method further includes providing recommendations to the user towards purchasing the part for the appliance from an original equipment manufacturer instead of getting a replica.

In yet another embodiment, a computer-readable media is discussed having computer-executable instructions embodied thereon that when executed by one or more processors, facilitate a logistics method that uses an application to push a notification as a function of proximity for an appliance that needs a part for replacement. The logistics method consists of detecting usage of the appliance via a sensor at a first location and the sensor for detecting usage of the appliance is a usage timer. The logistics method further includes using data from the sensor to determine the part needed for the appliance and storing inventory information at different locations for multiple parts for the appliance through an inventory database at a second location. The logistics method further includes transmitting data for the appliance between the first location and the second location. The sensor contacts the inventory database when the appliance is getting faulty and/or the appliance needs the part for replacement. The logistics method further includes tracking a location of the user device using a trilateration sensor and determining distance between the location of the user device and different locations having the part by a routing algorithm. Based on information from the trilateration sensor and routing algorithm, triggering the alerting module of the user device when the location of the user device is within a determined distance from different locations having the part in stock. The logistics method further includes providing recommendations to the user towards purchasing the part for the appliance from an original equipment manufacturer instead of getting a replica.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a logistics system that uses an application to push a notification as a function of proximity for an appliance;

FIG. 2 illustrates components of the logistics system communicating via a network to push notification on a user device;

FIG. 3 illustrates a front and side view of the appliance at a first location that needs a replacement part;

FIG. 4 illustrates a parts algorithm that uses a sensor to determine the part needed for the appliance;

FIG. 5 illustrates a log from an inventory database at a second location that stores inventory information at multiple locations for different parts of the appliance;

FIG. 6 illustrates a routing algorithm to determine distance between the location of the user device and multiple locations having the part;

FIG. 7 illustrates a logistics system that integrates online vendors on the application to recommend buying from original equipment manufacturers (OEMs);

FIG. 8 illustrates interface of the application on the user device to notify about availability and location of part in nearby locations;

FIG. 9 illustrates a map on the application guiding a user towards an exact point of presence of the part within the location;

FIG. 10 illustrates a method for using the application to push the notification as a function of proximity for the appliance; and

FIG. 11 illustrates a method of integrating online vendors on the application to recommend buying from original equipment manufacturers (OEMs) as an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

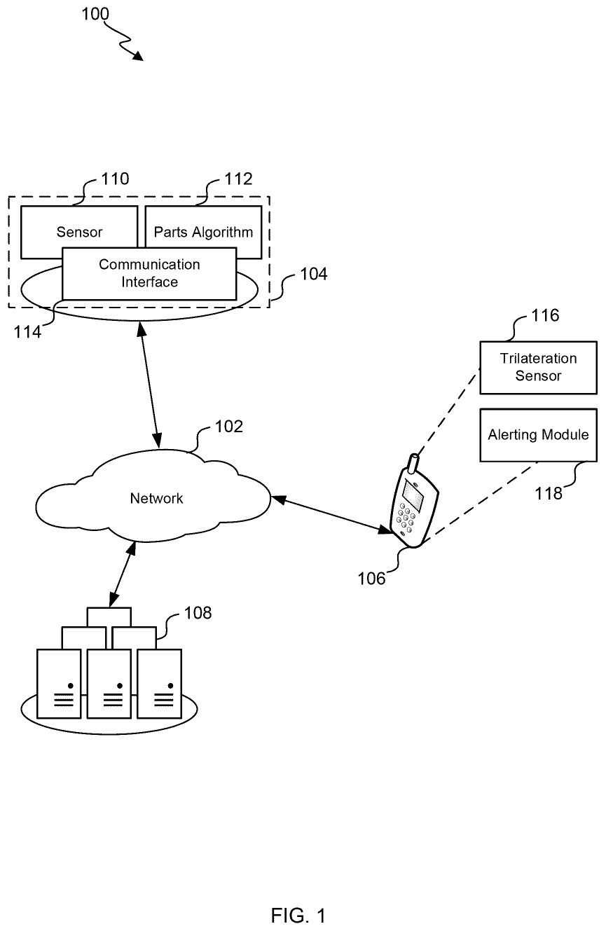

Referring to FIG. 1, a logistics system 100 that uses an application to push a notification as a function of proximity for an appliance 104 is shown. The logistics system 100 includes a network 102, an appliance 104 at a first location, a user device 106, and an inventory database 108 at a second location. The appliance 104 at a first location is a consumable that includes a sensor 110, a parts algorithm 112, and a communication interface 114 among other components. Consumables are goods, such as household items, often made up of different components that individuals or businesses use or wear out and require regular replacements. In this application, consumables are referred to as “appliances” and their individual components are referred to as “parts”.

The sensor 110 detects the usage of the appliance 104 and the parts algorithm 112 determines the part of the appliance 104 that needs replacement. The appliance 104 at the first location uses the communication interface 114 to transmit data between the first location and the inventory database 108 at the second location. The sensor 110 contacts the inventory database 108 when the appliance 104 is getting faulty and/or the appliance 104 needs the part for replacement. The network 102, is any Internet network connecting a user at the user device 106 along with the appliance 104 and the inventory database 108. The inventory database 108 at the second location, stores inventory information at multiple locations for different parts of the appliance 104. The inventory database 108, maintains and updates a log for different parts of the appliance 104 available at different locations. This is done to notify the user, if the part is not available at a particular location or when it will be in stock again. In this application, the multiple locations from the inventory database 108 refers to the stores that have the part available in stock.

The user device 106 has a trilateration sensor 116 and an alerting module 118 to track location and to trigger the notification as the function of proximity for the appliance 104. The trilateration sensor 116 employs an algorithm to determine distance between the user device 106 and the locations having the required part. Based upon information from the algorithm and the trilateration sensor 116, the alerting module 118 triggers and sends notification on an application of the user device 106 when it is within a determined distance from the location having the part in stock.

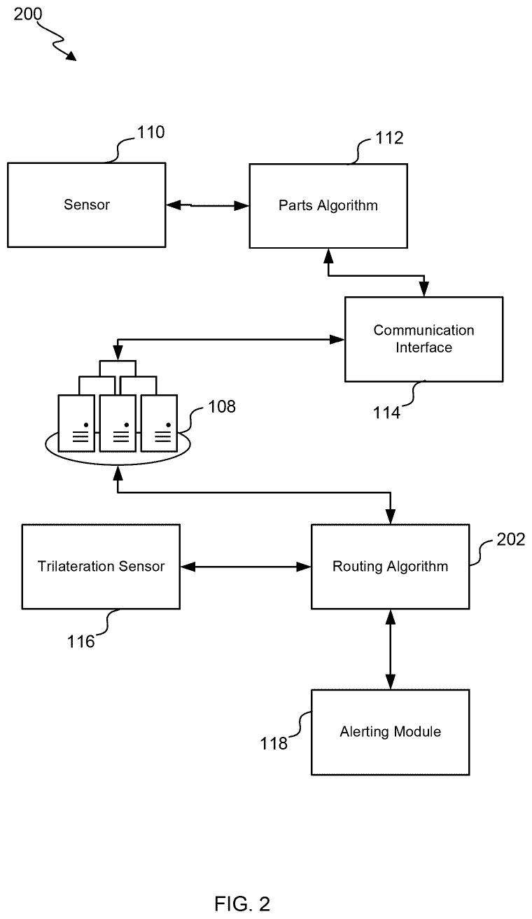

Referring next to FIG. 2, components 200 of the logistics system 100 communicating via the network 102 to push notification on the user device 106 are shown. The components 200 of the logistics system 100 include a sensor 110, a parts algorithm 112, a communication interface 114, and an inventory database 108. The components 200 of the logistics system 100, further includes a trilateration sensor 116, a routing algorithm 202, and an alerting module 118. The sensor 110 is present at the first location, commonly mounted on the appliance 104. The sensor 110 is a timer, that detects the usage of the appliance 104 by counting the period the appliance 104 has been running. The individual part of the appliance 104 has an optimum time where it works fine, and after that time is up, the part starts wearing off. The sensor 110 keeps record of the time to provide data for the parts algorithm 112.

The parts algorithm 112 determines, which part of the appliance needs a replacement. This can be done by simply getting input from the sensor 110 or a machine learning algorithm can be used to learn usage habits of the user and then making decisions from there. The inventory database 108 is a management system at a second location that maintains logs of appliances and their parts and updates the user when the part comes back in stock. Multiple partners or stores have their items enlisted at the inventory database 108. In this way, the inventory database 108 can search among multiple locations that have the part in stock and can guide the user efficiently. The trilateration sensor 116 tracks the location of the user device 106.

The trilateration sensor 116 operates by leveraging distance measurements from multiple known reference points to determine the position of an unknown point in space. These reference points, often satellites in global positioning system (GPS) or fixed beacons in indoor positioning systems, provide precise coordinates. The trilateration sensor 116 can also use other technologies or navigation systems such as Russian or Chinese navigation systems if GPS is not available. The trilateration sensor 116 measures the distance from the unknown point to each reference point using signal propagation or signal strength. Individual distance measurement defines a sphere around the reference point, with the unknown point lying somewhere on the surface. By intersecting these spheres, the trilateration sensor 116 calculates the coordinates of these points. However, in three-dimensional space, the intersection yields two possible points, with one often discarded due to being non-sensical. Mathematical algorithms are implied to calculate the most likely coordinates, considering factors such as measurement accuracy and error correction techniques to improve precision. Examples of such algorithms include least square method, iterative trilateration, and non-linear optimization techniques etc.

Once the position from the trilateration sensor 116 is determined, the logistics system 100 uses the routing algorithm 202, for navigation or tracking purposes. Various routing algorithms can be used based on the requirements of the systems. One such routing algorithm is Dijkstra's algorithm, which is used for finding the most efficient path between the current location and the destination. For routing based on trilateration data, the Floyd-Warshall Algorithm can be used to make decisions based solely on local information and not considering the global structure of the network. Another approach is using dynamic programming, which is particularly useful for optimizing routes in dynamic environments, where conditions may change over time. The routing algorithm 202 uses the data from the trilateration sensor 116 and the inventory database 108 to find out the most suitable route.

The output of the routing algorithm 202 is sent to the user device 106. The alerting module 118 of the application of the user device 106, notifies the user to make a purchase for the needed replacement. The notification is then sent by the alerting module 118, when the user device 106 is within a determined distance of the location having the part.

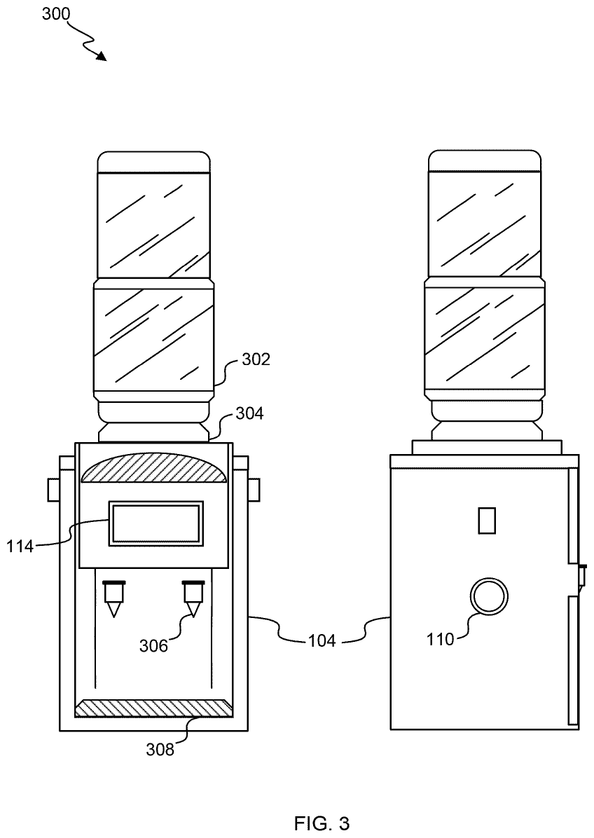

Referring next to FIG. 3, a front and side view of the appliance 104 at a first location that needs to replace a part is shown. The exemplary appliance in this application is a water cooler. Other examples of appliances also fall under the scope of this application. The appliance 104 has a water tank 302, a separator 304, a communication interface 114, a hot/cold water nozzle 306, and a drip tray grill 308 among other components. Other components of the appliance 104 are not shown. The side view of the appliance 104 shows the sensor 110. The sensor 110 is any sensor or a usage timer to measure the usage of the appliance 104.

The sensor 110 operates by detecting specific actions or changes associated with the consumption process. The actions or changes depends upon the type of item which is being consumed. For instance, in liquid consumables, such as fuel or beverages, the sensor 110 is a flow meter or a weight sensor that measures the volume or weight dispensed. Alternatively, for solid appliances or consumables motion or optical sensors are used to track the dispensing, removal, or consumption. As the appliance 104 is being used, the sensor 110 collects data on parameters such as volume, weight, or frequency of use. This data is processed to drive insights such as usage patterns, consumption behaviors, and inventory levels. Processed data can be stored locally or transmitted wirelessly to centralized systems for analysis and integration with larger platforms like supply chain or inventory management systems i.e., the inventory database 108.

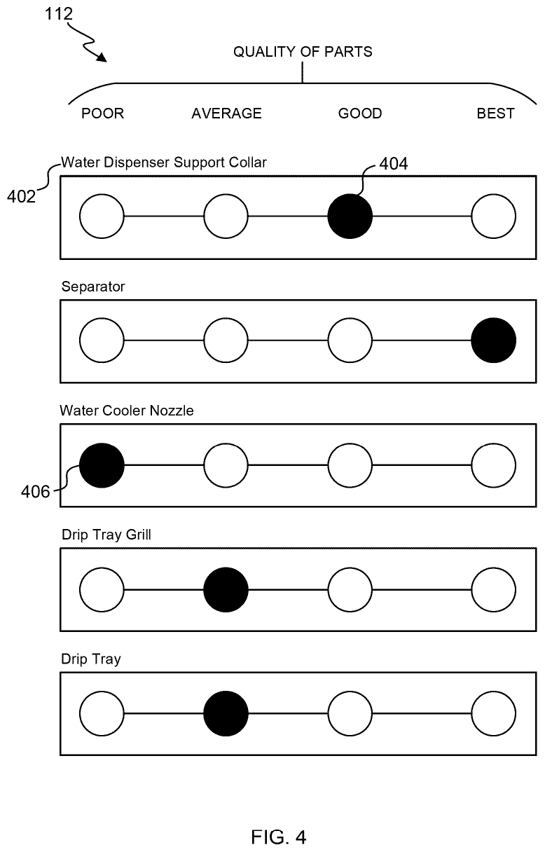

Referring next to FIG. 4, the parts algorithm 112 that uses data from the sensor 110 to determine the part needed for the appliance 104 is shown. The parts algorithm 112 can be used by the sensor 110 or a processor can be used for computing. The parts algorithm 112 of FIG. 4 is an exemplary parts algorithm. Other techniques and methods can be used to determine which part of the appliance 104 needs replacing. The parts algorithm 112 classifies the quality of parts of the appliance 104 as poor, average, good, or best. Five exemplary parts of the appliance 104 i.e., water cooler, are shown. At section 402, quality of a water dispenser support collar is shown.

Other parts are, a separator, water cooler nozzle, drip tray grill, and a drip tray. At section 404, the quality of the water dispenser support collar is classified as good. Whereas at section 406, the quality of water cooler nozzle is classified as poor. This means that the water cooler nozzle needs an immediate replacement. The sensor 110 determines the usage of the parts of the appliance 104. Based on the data from the sensor 110 and other parameters, the parts algorithm 112 finds which are the parts that are weary or damaged. In this way, the user are informed to make decisions and purchase.

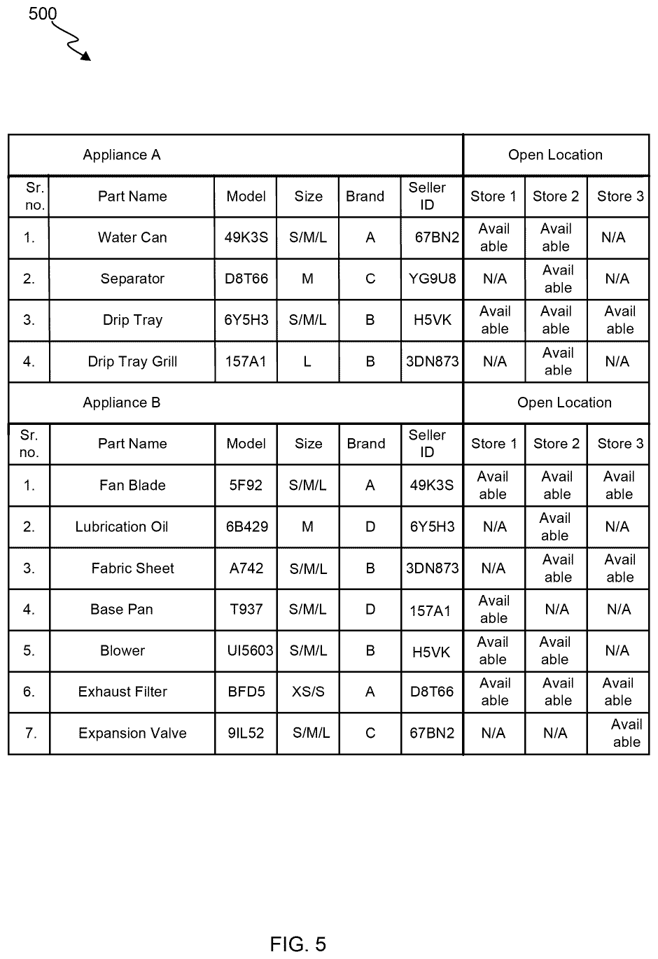

Referring next to FIG. 5, a log 500 from the inventory database 108 at a second location, stores inventory information at multiple locations for different parts of the appliance 104 is shown. The log 500 shows two appliances; appliance A and appliance B. It shows the names of the parts, their model, size, and brand of specific appliance. The inventory database 108 also keeps a record of the availability of parts of the appliances at multiple locations or stores. If the part is not available at one location, the inventory database 108 connects other stores and finds out if they have the part in stock. The log 500 from the inventory database 108, guides the user by providing the location of the store on the map.

The inventory database 108 can further inform the user when the part becomes available at one of the locations. Furthermore, the inventory database 108 keeps a record of the trends and notifies when a part is going low in supply or getting out of stock. The inventory database 108 also has partnerships with some stores such as Walmart, Lowes, Target, etc. The appliances or products from the partnered stores, are recommended to the user, and the inventory database 108 makes sure that their products never go out of stock.

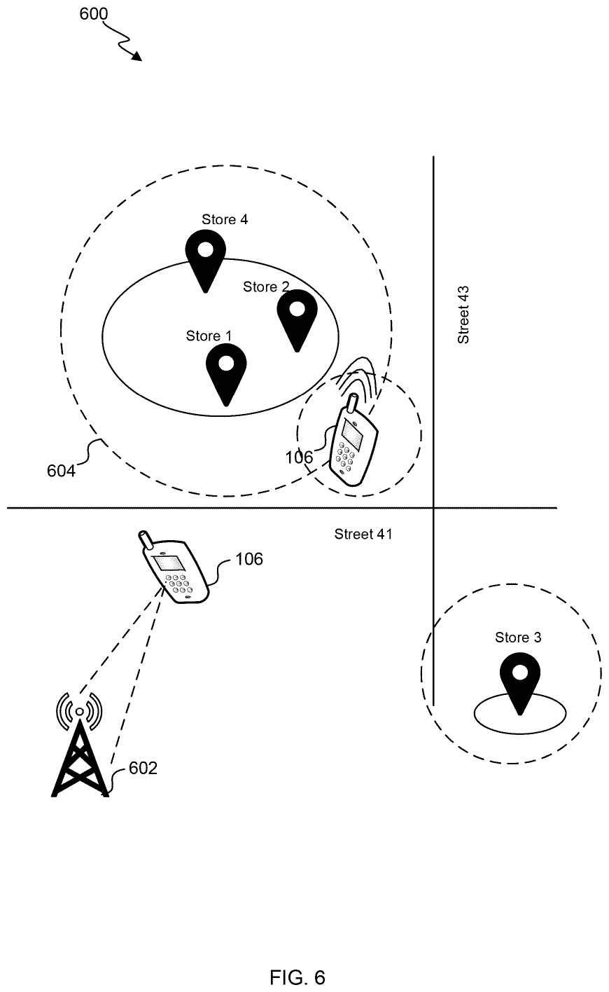

Referring next to FIG. 6, the routing algorithm 202 to determine distance between the location of the user device 106 and multiple locations having the part is shown. The user device 106 is equipped with Wi-Fi and GPS capabilities. The user device 106 detects signals from nearby Wi-Fi access points and utilizes GPS satellites 602 for location tracking. Firstly, the user device 106 collects signals from several nearby Wi-Fi access points. Individual Wi-Fi access point serves as a fixed reference point with known coordinates. The strength of the signals received from these access points provides an indication of the user device 106's distance from each location. The user device 106 then uses trilateration techniques to calculate its precise location by intersecting the spheres of possible locations around individual access point based on signal strength.

For instance, the user device 106 detects signals from three nearby Wi-Fi access points: Point A, Point B, and Point C. By measuring the signal strength and calculating the distances from respective access points, the user device 106 determines its location at the intersection point of the spheres 604, created around these access points. This calculated location represents the user's current position.

Once the user device 106 has determined its location, it then queries a database or utilizes a mapping service to identify nearby stores within a set radius. The determined distance or set radius is indicated by the spheres 604. The database or mapping service contains information about the locations of various stores, such as supermarkets, restaurants, or retail outlets. Using the calculated location, the user device 106 sends a request to the database or mapping service, asking for nearby stores within a specified distance. The service then returns a list of stores located within the given radius of the user device's current position, i.e., store 1, store 2, and store 4.

After receiving the list of nearby stores, the user device 106 presents this information to the user through a user-friendly interface, such as a map application. The user then selects a desired store from the list, and the user device 106 provides directions to that store using a routing algorithm. For example, the user device 106 can employ a routing algorithm like Dijkstra's algorithm, to find the direct path from the user's current location to the selected store. The algorithm considers various factors such as distance, traffic conditions, and mode of transportation to determine the ideal route.

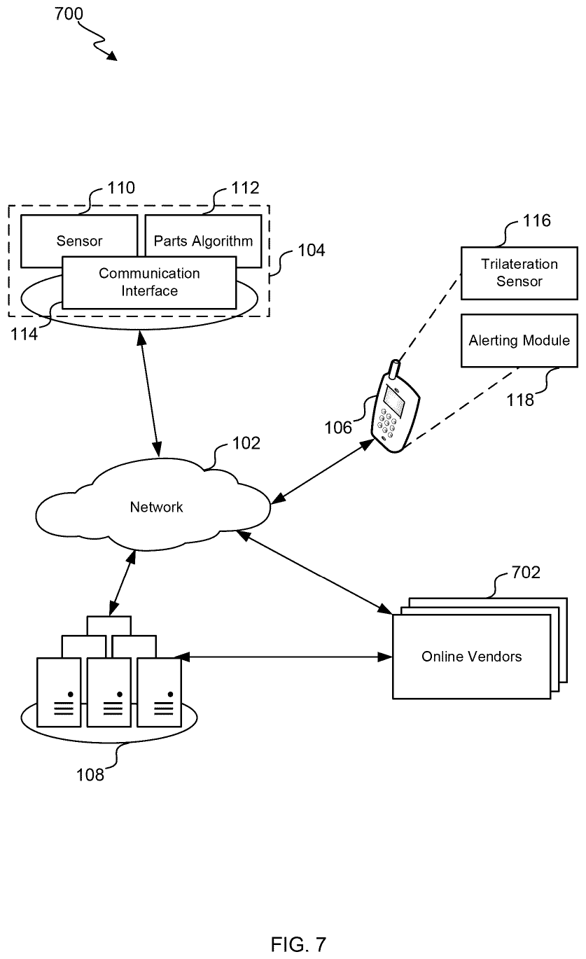

Referring next to FIG. 7, an exemplary logistics system 700 that integrates online vendor(s) 702 on the application to recommend buying from original equipment manufacturers (OEMs) as shown. The exemplary logistics system 700 comprises a network 102, an appliance 104 at a first location, a user device 106, an inventory database 108 at a second location, and online vendor(s) 702. The appliance 104 has a sensor 110, parts algorithm 112, and a communication interface 114, which detects usage and determines the part that needs a replacement. The communication interface 114 transmits data between the first location and the inventory database 108 at the second location. The inventory database 108 stores inventory information at multiple locations for different parts of the appliance 104. The user device 106 has a trilateration sensor 116 and an alerting module 118, to receive notifications as a function of proximity for the appliance 104. The trilateration sensor 116 uses an algorithm to determine the distance between the user device 106 and the locations having the entailed part. The alerting module 118 triggers and sends notifications when the user device 106 is within a determined distance, from the location that has the part in stock.

The online vendor(s) 702 are partnered with stores such as Walmart, Lowes, and Target, etc. These stores or the online vendor(s) 702 market their appliances and products through the logistics system 100. For companies like Amazon™ or Midea™ that do not have a physical store of their own, the online vendor(s) 702 shows its products on its partnered stores i.e., Lowes™, Target™ etc. The online vendor(s) 702 are also partnered with warehouses that do not have online presence. As a result, the user can check the availability of the part at such warehouses online. The inventory database 108 ensures that the part of the appliance 104 needed, is available at the online vendor(s) 702. The logistics system 100 also recommends users to buy through the online vendor(s) 702. Furthermore, the logistics system 100 recommends users to buy through the genuine original equipment manufacturers (OEMs) available through the online vendor(s) 702 instead of buying cheap replicas. The online vendor(s) 702 also suggest an alternative purchase path to the users through the application on the user device 106. The alternative purchase paths suggest a better deal or package with buying the part from OEM that might interest the user.

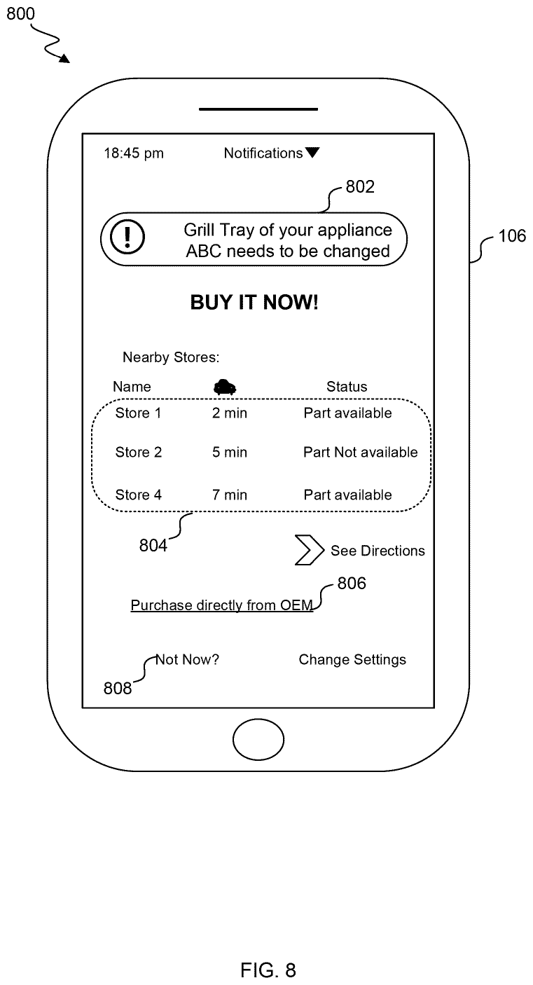

Referring next to FIG. 8, an interface 800 of the application on the user device 106 to notify about availability and location of part in nearby locations is shown. The interface 800 shows a notification being pushed on the user device 106 via the alerting module 118. The notification is sent when the user device 106 is within the determined distance of the location that has the needed part in stock. At section 802, the alerting module 118 informs the user that the drip tray grill 308 of the appliance 104 needs a replacement. The weary part is determined by the parts algorithm 112 that takes its input from the sensor 110. The notification prompts the user to make a purchase when one of the locations has the part. The interface 800 shows the names of the nearby locations, travel time, and the status of the part at those locations in section 804. The status of the part tells whether the part is available or in stock at said location. At section 804, multiple locations near the location of the user device 106 are given. The user can make his choice based on his preference.

The user can see directions on the map towards one of the locations via the application. At section 806 instead of surfing through the locations in person or googling and ordering from suspicious sites, the user can purchase directly from the OEMs. In case when the OEM is not selling, the user can also select a partner store at the application to purchase the part. At section 808, the user can set the time and frequency of the notifications on the application of the user device. For instance, the user can configure the time when he wants to get the notification i.e., user's preferred hours are between 10:00 a.m. to 10:00 p.m. For example, if the user device 106 is near the locations that have the needed part at midnight, the alerting module 118 will not send the notification. The alerting module 118 will hold the notification and schedule it for the next time. Next time if the user device 106 is nearby one of the locations during the preferred hours, say noon, then the alerting module 118 will push the notification on the application.

In one embodiment, the user can opt for the option of home delivery instead of store pickup from one of the locations. When the user device 106 is near the locations, the application will ask the user, if he wants to go and buy or simply wants to order online. The option is provided on the application of the user device 106, which is not shown here. The online vendors 702 can also send notifications such as “12 xyz parts of abc appliance have been sold in last two hours” to prompt the user to make a timely purchase.

When the user goes to one of the locations and buys the needed part for the appliance 104, the online vendor(s) 702 or the said location confirms purchase through the inventory database 108. When the part is replaced on the appliance 104, the sensor 110 detects the change. In this way, the usage timer on the sensor 110 is reset, and the appliance 104 becomes ready to use again.

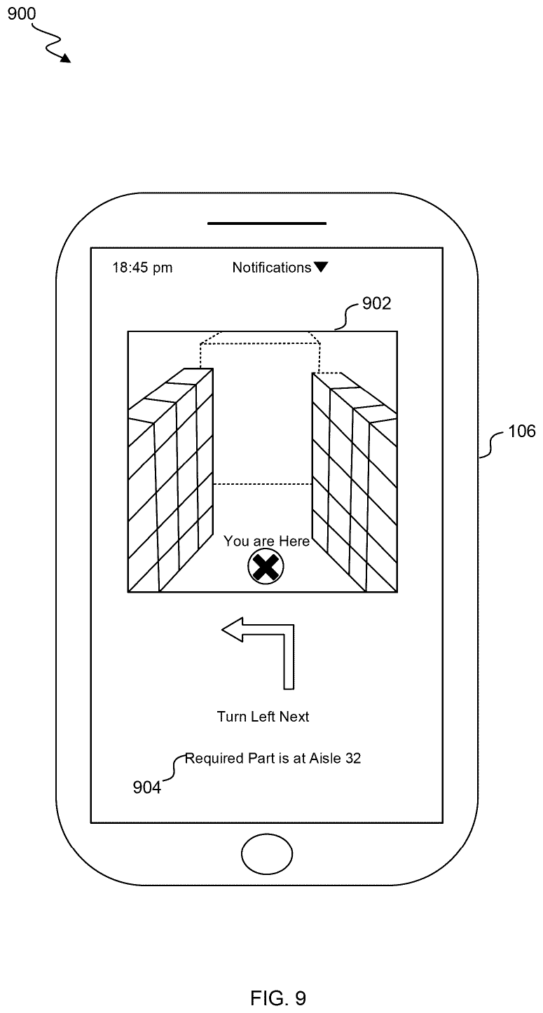

Referring next to FIG. 9, a map 902 on the application guiding 900 users towards an exact point of presence of the part within the location is shown. The user device 106 has Wi-Fi access and uses GPS satellites for location tracking. Moreover, the partnered stores or the online vendor(s) 702 for big companies have also shared their store map or layout on the application of the user device 106. The user device 106 shows the map 902 of the location, having the part in stock. The map 902 displays the aisles and floor plan of the location, that has the part on the user device, indicating multiple aisles and shelves through a global positioning system (GPS). It also provides directions towards the needed part of the appliance 104. The user device 106 also provides information or the exact point of presence of the part that is needed on the application in section 904.

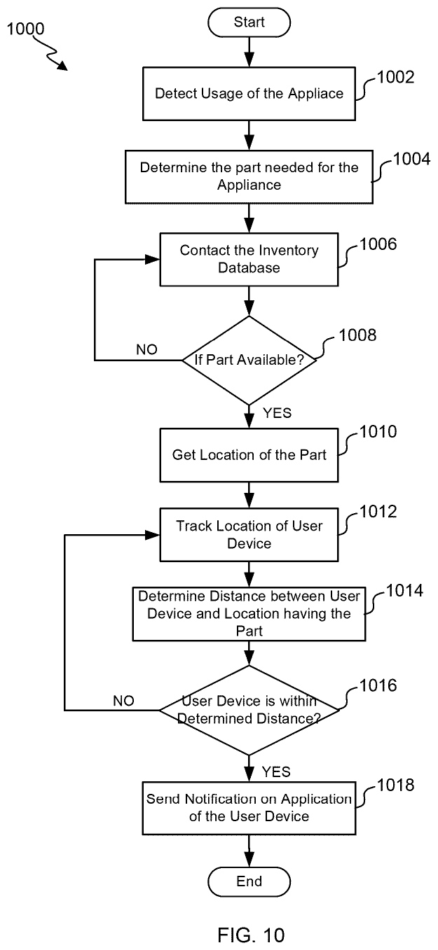

Referring next to FIG. 10, a logistics method 1000 of using the application to push the notification as a function of proximity for the appliance 104 is shown. The logistics method 1000 utilizes location-based features, to monitor if the user device 106 has entered or is near one of the partner box stores/locations, for example Walmart or Lowes. The logistics method 1000 further determines if these locations have the part, such as a water filter, of the appliance 104 that needs to be replaced or soon replaced. The application of the user device 106 provides a push notification to inform the user, that the partner stores have the part available and where in the store.

At block 1002, the sensor 110 at the first location detects the usage of the appliance 104. The usage of the appliance 104 is detected by the usage or the condition of the individual parts of the appliance 104. The sensor 110 is a usage timer that measures the running or usage period of different parts of the appliance 104. For example, the sensor 110 is a weight sensor or a flow meter which monitors the volume or weight supplied in liquid consumables, like gasoline or drinks. Motion or optical sensors are employed as an alternative to track the dispensing, removal, or consumption of solid appliances or consumables. The sensor 110 records information including weight, volume, and frequency of usage when the appliance 104 is in use.

At block 1004, the parts algorithm 112 determines, the part of the appliance 104 that has been damaged or not in a good condition and needs to be replaced. The data from the sensor 110 is used by the parts algorithm 112, to determine which part of the appliance 104 is not in its optimum condition. The parts algorithm 112 can be a simple quality check algorithm, that employs the usage time of the parts to determine their quality, as described in FIG. 4. The parts algorithm 112 can also be a machine learning tool which uses different parameters such as material of the part, and usage behavior patterns to determine when and which part of the appliance 104 needs to be replaced. In addition to that, the machine learning tool keeps track of the location of the appliance. For example, water in a water cooler at KY location might need less filtering as compared to the water in water cooler at WI location.

At block 1006, the communication interface 114 of the appliance 104, contacts the inventory database 108 at the second location. The inventory database 108 keeps record of the parts of the appliances and their availability at multiple locations or stores. If the part is not available at one location, the inventory database 108 connects other stores and finds out if they have the part in stock.

At block 1008, if the part is available at one of the locations, then that location is shared on the user device 106. Otherwise, if the part is not available in any of the locations registered at the inventory database 108, then the inventory database 108 simply keeps on searching until it finds a location having the part or the part comes back in stock at one of the locations.

At block 1010, the user device 106 gets the location of the part at different stores that have that part in stock. At block 1012, the trilateration sensor 116 tracks the location of the user device 106. The trilateration sensor 116 calculates an unknown point location in space, using distance measurements from reference sites. These sites, often GPS satellites or indoor beacons, provide exact coordinates. The trilateration sensor 116 crosses these spheres to determine the unknown point's coordinates. These coordinates then tell the location of the user device 106. At block 1014 when the location of the user device 106 has been determined, the routing algorithm 202, determines the distance between the user device 106 and the locations having the part in stock. The routing algorithm 202 takes into account the traffic conditions, mode of transportation, and other parameters while finding the suitable route. The distance is often shown as travel time on the application of the user device 106.

At block 1016, the routing algorithm 202 checks if the user device 106 is within a determined distance from the locations having the part in stock. If yes, then a notification is pushed on the user device 106. Otherwise, the trilateration sensor 116 keeps on tracking the location of the user device 106, unless it reaches within set radius of the locations having the part.

At block 1018, the alerting module 118 sends a notification on the application of the user device 106, if it is within a determined distance of the location having the part. The notification is sent only within the preferred time frame set by the user. The notification prompts the user to make a purchase from the nearby location having the needed part.

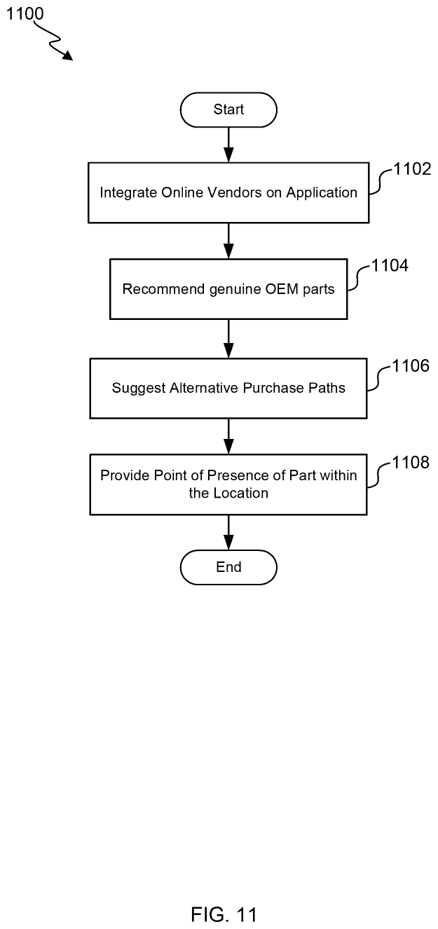

Referring next to FIG. 11, a method of integrating 1100 the online vendor(s) 702 on the application to recommend buying from original equipment manufacturers (OEMs) as an embodiment which is shown. At block 1102, the online vendors 702 are integrated into the logistics system 100. The online vendor(s) 702 are partnered stores such as Walmart, Lowes, Target, etc. These stores or the online vendor(s) 702 market their appliances and products through the logistics system 100. The inventory database 108 ensures that the part of the appliance 104 needed is available at the online vendor(s) 702.

At block 1104, the application of the user device 106 provides recommendations to the user to buy the part from genuine OEMs instead of buying a cheap replica. The application further allows the user to purchase directly from the OEMs, instead of googling and searching on the Internet for the part. At block 1106, the application of the user device 106 suggests alternative purchase paths to the users to provide more options. In this way, the user can make better decisions using the help of the online vendor(s) 702.

At block 1108, the application of the user device 106, provides an exact point of presence of the part within the location having the part. The online vendor(s) 702 share their store layout on the application so the user can easily find the part he needs in the location.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A logistics system that uses an application to push a notification as a function of proximity for an appliance, the logistics system comprises:
a sensor at a first location to detect usage of the appliance;
a parts algorithm using the sensor to determine a part needed for the appliance;
an inventory database at a second location that stores inventory information at a plurality of locations for a plurality of parts for the appliance, wherein the plurality of parts includes the part;
a communication interface for the appliance to transmit data between the first location and the second location;
a trilateration sensor to track a location of a user device;
a routing algorithm to determine distance between the location of the user device and the plurality of locations; and
based on information from the trilateration sensor and the routing algorithm, an alerting module of the user device that triggers when the location of the user device is within a determined distance from the plurality of locations having the part in stock.

2. The logistics system of claim 1, wherein the sensor that detects usage of the appliance is a usage timer.

3. The logistics system of claim 1, wherein the sensor contacts the inventory database when the appliance is getting faulty and/or the appliance needs the part for replacement.

4. The logistics system of claim 1, wherein the logistics system further provides recommendations to a user for purchasing the part for the appliance from an original equipment manufacturer instead of getting a replica.

5. The logistics system of claim 1, wherein the logistics system is integrated with a plurality of online vendors that suggest an alternative purchase path to a user.

6. The logistics system of claim 1, wherein a user sets a frequency and a time for the notification on the application of the user device.

7. The logistics system of claim 1 wherein the application displays on the user device a floor plan of a location of the plurality of the locations having the part, indicating a plurality of aisles and shelves, using a global positioning system (GPS).

8. A logistics method that uses an application to push a notification as a function of proximity for an appliance, the logistics method comprises:
detecting usage of the appliance at a first location;
determining a part needed for the appliance using a sensor;
storing inventory information at a plurality of locations for a plurality of parts for the appliance at a second location, wherein the plurality of parts includes the part;
transmitting data for the appliance between the first location and the second location;
tracking a location of a user device;
determining distance between the location of the user device and the plurality of locations; and
based on information from a trilateration sensor and a routing algorithm, pushing the notification to the user device when the location of the user device is within a determined distance from the plurality of locations having the part in stock.

9. The logistics method of claim 8, wherein the sensor that detects usage of the appliance is a usage timer.

10. The logistics method of claim 8, wherein the sensor contacts an inventory database when the appliance is getting faulty and/or the appliance needs the part for replacement.

11. The logistics method of claim 8, wherein the logistics method further provides recommendations to a user for purchasing the part for the appliance from an original equipment manufacturer instead of getting a replica.

12. The logistics method of claim 8, wherein the logistics method is integrated with a plurality of online vendors that suggest an alternative purchase path to a user.

13. The logistics method of claim 8, wherein a user sets a frequency and a time for the notification on the application of the user device.

14. The logistics method of claim 8, wherein the application displays on the user device a floor plan of the location of the plurality of the locations, having the part, indicating a plurality of aisles and shelves, using a global positioning system (GPS).

15. A computer-readable media having computer-executable instructions embodied thereon that when executed by one or more processors, facilitates a logistics method that uses an application to push a notification as a function of proximity for an appliance, the computer-readable media comprises:
detecting usage of the appliance at a first location;
determining a part needed for the appliance using a sensor;
storing inventory information at a plurality of locations for plurality of parts for the appliance at a second location, wherein the plurality of parts includes the part;
transmitting data for the appliance between the first location and the second location;
tracking a location of a user device;
determining distance between the location of the user device and the plurality of locations; and
based on information from a trilateration sensor and a routing algorithm, pushing the notification to the user device when the location of the user device is within a determined distance from the plurality of locations having the part in stock.

16. The computer-readable media of claim 15, wherein the sensor that detects usage of the appliance is a usage timer.

17. The computer-readable media of claim 15, wherein the sensor contacts an inventory database when the appliance is getting faulty and/or the appliance needs the part for replacement.

18. The computer-readable media of claim 15, wherein the logistics method further provides recommendations to a user for purchasing the part for the appliance from an original equipment manufacturer instead of getting a replica.

19. The computer-readable media of claim 15, wherein a user sets a frequency and a time for the notification on the application of the user device.

20. The computer-readable media of claim 15, wherein the application displays on the user device a floor plan of a location of the plurality of the locations, having the part indicating a plurality of aisles and shelves, using a global positioning system (GPS).
